(19) United States
(12) Patent Application Publication
(10) Pub. No.: US 2021/0348400 A1
(43) Pub. Date: Nov. 11, 2021

(54) A METHOD OF FORMING A BUILDING

(71) Applicant: Charles Bree, Mercer (NZ)

(72) Inventor: Charles Bree, Mercer (NZ)

(21) Appl. No.: 17/266,927

(22) PCT Filed: Aug. 8, 2019
(86) PCT No.: PCT/NZ2019/050093

§ 371 Date: Feb. 8, 2021

(30) Foreign Application Priority Data
Aug. 8, 2018 (NZ) 745100

(51) Int. Cl. E04G 11/02; E04G 11/04; E04B 1/32; B29C 44/02; B29C 44/36; E04B 1/35

(52) U.S. Cl. CPC E04G 11/02; E04G 11/04; E04B 1/32; B29K 2075/00; B29C 44/367; E04B 1/3505; B29C 44/022

(57) ABSTRACT

There is currently a demand for buildings that can be formed both quickly and economically. These buildings require the addition of heat insulation to walls or roofs because the materials from which they are otherwise formed have insufficient ability to protect against the cold. This can add undesirable expense and slow down production rates. A method is disclosed of forming a building that addresses this problem. The method comprises arranging a door frame, window frame or edge support frame at a mould and spraying a first spray material onto the outside of the mould so that the spray material sets generally in the shape of the mould and substantially embeds the frame. The first material and the frame is removed from the mould and a second different spray material is sprayed onto the first spray material to provide a skin therefor.

### FIELD OF THE INVENTION

A preferred form of the invention relates to spray forming a building or panels for producing a building.

### BACKGROUND

There is currently a demand for buildings that can be formed both quickly and economically to satisfy the accommodation needs of people. Many known buildings require the addition of heat insulation to walls or roofs because the materials from which they are otherwise formed have insufficient ability to protect against the cold. This can add undesirable expense and slow down production rates.

### OBJECT OF THE INVENTION

It is an object of a preferred form of the invention to go at least some way towards addressing the above problem. However it should be understood that the invention has more general applicability and that any objects or advantages of any preferred embodiment should not be seen as a limitation on the claims. The object of the invention per se is simply to provide the public with a useful choice.

### INTERPRETATION

The term “comprising”, if and when used in this document in relation to a combination of steps or features, should be interpreted to mean that the combination may be supplemented by additional features, but does not have to be.

### SUMMARY OF THE INVENTION

According to one aspect of the invention there is provided a method of forming a building, comprising the steps of:
arranging a door frame, window frame or edge support frame at a mould;
spraying a first spray material onto the outside of the mould so that the spray material;
   sets generally in the shape of the mould; and
   substantially embeds the frame;
removing the first spray material and the frame from the mould; and
spraying a second different spray material onto the first spray material to provide a skin therefor.

Optionally the first spray material comprises polyurethane foam.

Optionally the second spray material comprises polyurea.

Optionally the method is used to produce a wall-roof combination panel for use as part of the building.

Optionally the edge support frame is substantially embedded at an edge of the panel.

Optionally the second spray material envelopes the first spray material and the frame.

Optionally part of the skin is applied before the first spray material is removed from the mould.

Optionally the mould is curved in at least its vertical dimension for producing a complimentary shaped wall-roof combination panel.

Optionally the mould has a central ridge running vertically for forming a complimentary shaped ridge in a wall-roof combination panel.

Optionally the door frame straddles the central ridge to provide for a door opening in the wall-roof combination panel.

Optionally there are at least two of the edge support frames, one at each side of a wall-roof combination panel.

Optionally at least one of the edge support frames comprises a wooden beam.

Optionally the mould gives the wall-roof panel a stepped end.

Preferably the mould is used to create a series of individual separate wall-roof combination panels for the building, and such that:
the first spray material comprises polyurethane foam;
the second spray material comprises polyurea;
there are at least two of the edge support frames per panel, each support frame substantially embedded in and running upwards along a different end of the panel;
each panel is formed to have a joining step at at least one end;
the panels are arranged end-to-end in overlapping fashion at the joining steps;
fasteners are driven through the ends of the panels to connect them so that each fastener passes through the support frames of adjoining panels to hold them together;
each panel has a central ridge;
each panel curves inwards with respect to the building as the panel extends upwards;
at least one of the panels has a door frame substantially embedded in the polyurethane; and
at least one of the panels has a window frame substantially embedded in the polyurethane.

Optionally the door frame extends across either side the central ridge of the respective panel.

Optionally window frames are placed on the same mould in different positions for different panels formed for the same building, to give each panel a differently disposed window space.

### DRAWINGS

Some preferred embodiments of the invention are described below in relation to the accompanying drawings, of which:

FIG. 1 is an isometric view of a building that is portable and/or that can be readily disassembled for storage and re-use;

FIG. 2 is an isometric view of a mould used for forming the building;

FIG. 3 is a transverse cross-sectional view of a pair of adjoining wall-roof panels forming part of he building;

FIG. 4 is a transverse cross sectional view showing one of the panels partially formed;

FIG. 5 is an isometric of an alternative mould for forming a portable building;

FIG. 6 is an isometric view of a building formed by way of the mould of FIG. 5;

FIG. 7 is a further isometric view of a building formed by way of the mould of FIG. 5;

FIG. 8 is an isometric view illustrating a window formed in one or more of the above buildings;

FIG. 9 is an isometric view of a mould for forming a building showing a window frame prior to moulding.

### DETAILED DESCRIPTION

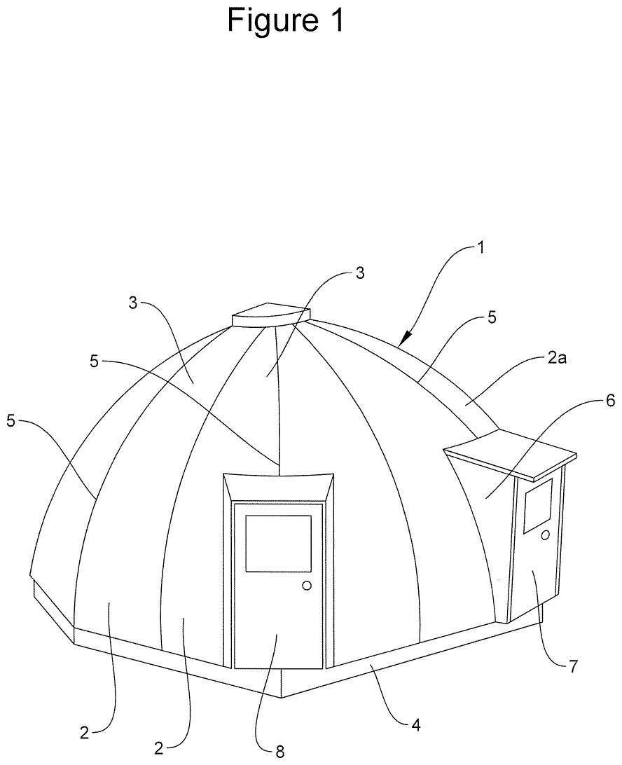

FIG. 1 illustrates a finished building 1 produced in accordance with a preferred embodiment of the invention. The building has been assembled from a series of curved wall panels 2 engaged with one another end-to-end. Each wall panel includes a roof portion 3 so that in essence it provides a wall and roof section all in one. The panels 2 are fastened to a foundation or base 4 that provides a floor for the building.

As shown, each panel 2 has a central stiffening ridge 5, and at least one of the panels 2a has an outward extension 6 providing space for a door 7. In some embodiments there may be a second or alternative door space, without an extension, as shown at 8.

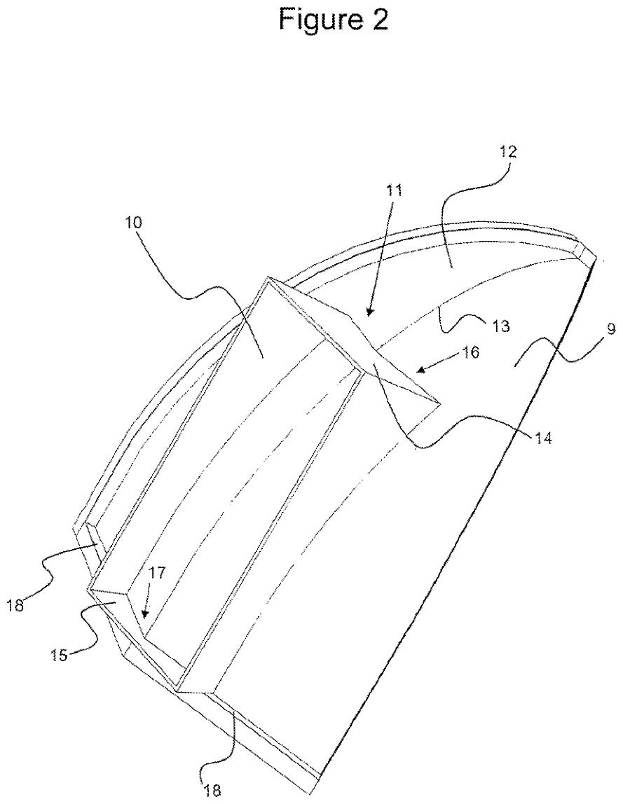

FIG. 2 illustrates a mould 9 for producing the panel 2a that incorporates the extension for the door 7. The mould is preferably metallic, for example steel, so that it has durability for substantial manufacturing re-use. To create the extension 9 for the door 7 a door frame 10 is held against the mould 9. As can be seen, the rear part 11 of the door frame 10 is contoured to match the outer surface 12 of the mould so as to enable a snug butting fit between the two. The door frame 10 is preferably formed from a suitable wooden material such as plywood (eg 17-20 mm thick), although any suitable alternative material can be used, for example fiberglass, etc.

With further reference to FIG. 2, the mould 9 has a central ridge 13 for creating the stiffening ridge 5 of the finished panel. The door frame 10 has horizontal upper and lower sheets 14, 15 each having a V shaped back-edge 16, 17 to compliment the contour of the mould at its central ridge 13. As shown, the lower edge 18 of the mould, either side of the central ridge 13, extends horizontally in a straight line fashion. The mould 9 curves or arcs back, away from its lower edge, as it extends upwards.

The same mould shown in FIG. 2 is used for wall panels that do not include a doorway. In that case the door frame 10 is simply omitted when the panel is created.

To form wall panels as above the outer face of the mould 9 is sprayed with rapid curing expanding polyurethane foam to a thickness commensurate with the end use of the building. For example when the building is for use in cold and wind exposed climates, the panel is made thicker than for warmer calmer climates. Optionally the polyurethane foam is sprayed to a thickness of 70-150 mm, preferably about 80-100 mm and more preferably about 80 mm. When the polyurethane foam is 100 mm thick the panel provides for a heat-insulation ‘R’ rating of about ‘6’.

When the wall panel is to include a doorway the door frame 10 is fitted as shown in FIG. 2, before the polyurethane is sprayed. Spraying is such that the door frame 10 becomes embedded in the polyurethane, except of course its rearmost edge which butts against the mould.

When the polyurethane has cured sufficiently the partially formed panel is removed from the mould 9. It is then sprayed with polyurea, preferably to a thickness of 1-6 mm, and most preferably 2 mm, to give the panel an enveloping elastomeric skin. It is best not to spray the polyurea until the polyurethane foam has cured fully, given that the foam may shrink as it sets. It has been found that the skin significantly increases the strength of the panel as it in a sense ties the front and rear faces of the panel together (eg it wraps completely around the left and right hand ends). In some embodiments the polyurea skin at the front of the panel may be sprayed onto the polyurethane prior to removal from the mould. When the desired number of panels has been made they are fastened end-to-end to give the building a generally rounded configuration.

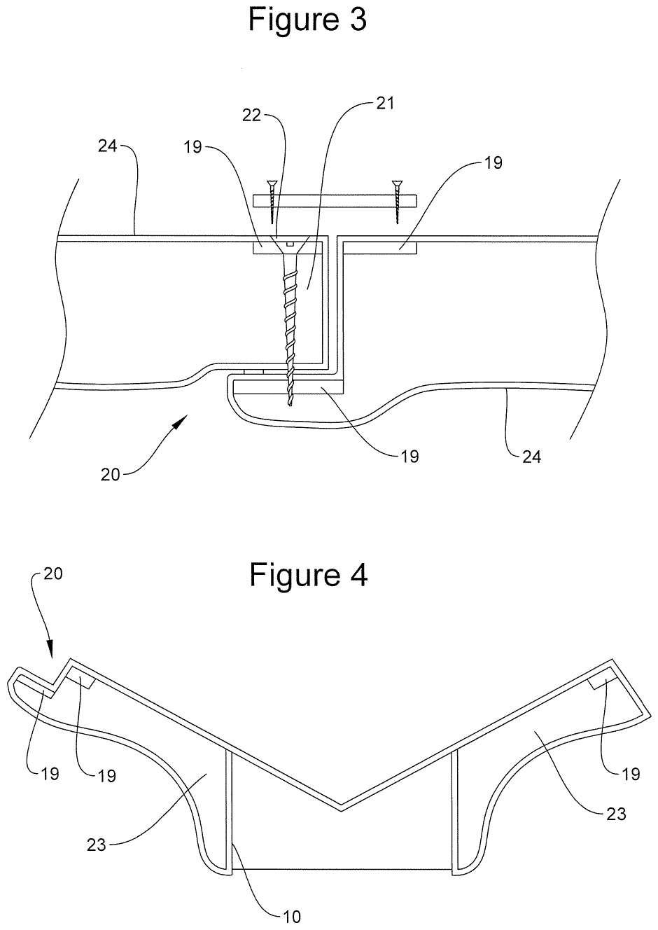

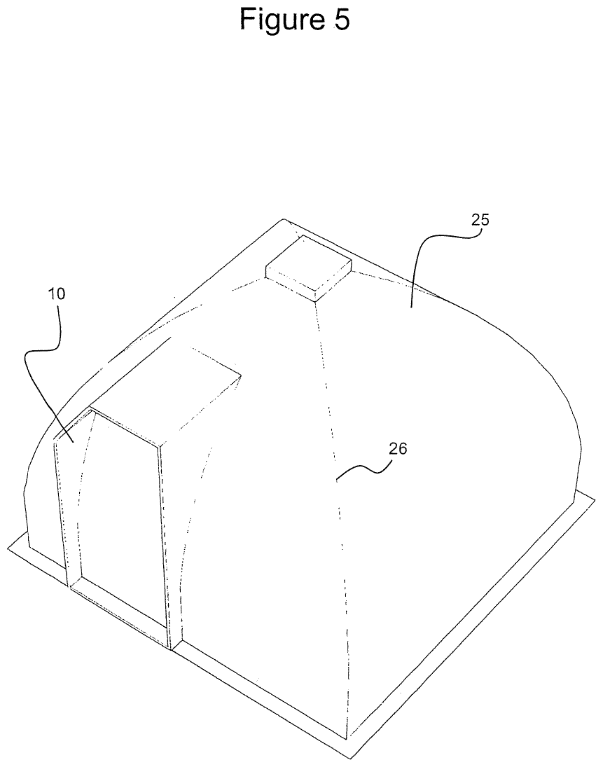

Referring to FIG. 3, to assist the end-to-end fastening, each panel has at least one embedded support frame 19 at each end. In each case the support frame 19 is in the form of a single vertically running wooden beam (eg a strip of plywood) that is square or rectangular in transverse cross section (eg 9-12 mm thick), although in other embodiments alternative materials may be used, for example plastic, steel, aluminium, etc. As shown, each panel has a stepped portion 20 at one side for receiving a complimentary edge 21 of the panel that is immediately adjacent. The support frames 19 provide a zone that a laterally disposed screw 22 can bite into to hold the ends of the panels securely together. The panels are screw fastened to one another at vertically spaced positions, each in the manner illustrated. As shown in FIG. 4, each panel may have three of the support frames 19, two at the stepped end and one at the other end. In each case the frames 19 are partially embedded in the polyurethane foam 23. The parts of the frames 19 that are not embedded by polyurethane are embedded by the polyurea skin 24 (see FIG. 3).

The building can be readily disassembled by removing the screws from the panels and releasing the panels from the base 4.

FIG. 5 illustrates a metallic building mould 25 used in a further embodiment of the invention. The mould is for receiving a spray covering of polyurethane foam in the manner described above, except that the whole building is sprayed in one application as opposed to only producing wall panels for later assembly. When the polyurethane has cured it is removed from the mould 25 and an enveloping polyurea skin is sprayed over it. The outer portion of the skin may or may not be sprayed before the polyurethane is removed from the mould 25. In the FIG. 5 embodiment there is no need for fastening panels end to end seeing as the walls of the building are continuous.

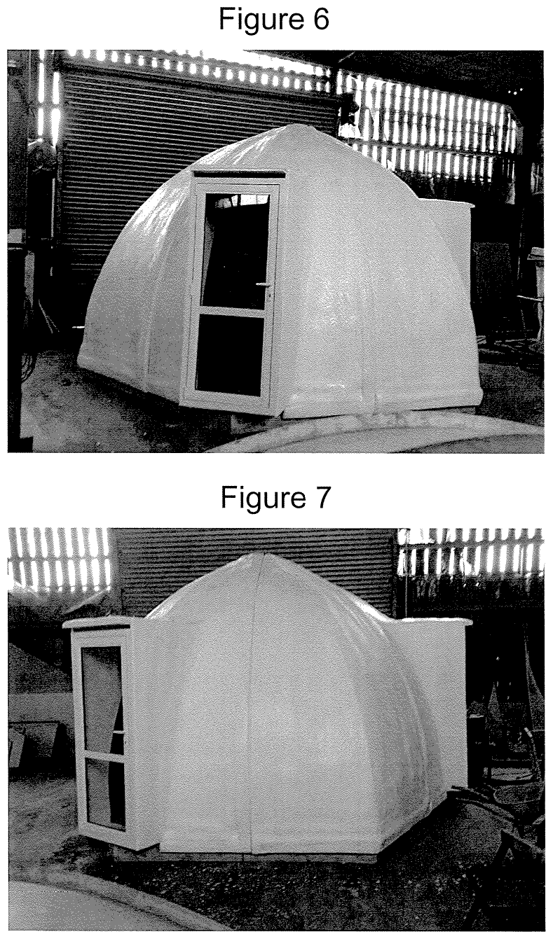

With further reference to FIG. 5, a door frame 10 of the same sort described above is butted against one side of the mould 25 so that it can be spray-embedded into the polyurethane. As shown, the door frame 10 does not straddle any of the corner ridges 26. FIGS. 6 and 7 illustrate finished buildings formed by way of a mould the same or similar to that of FIG. 5.

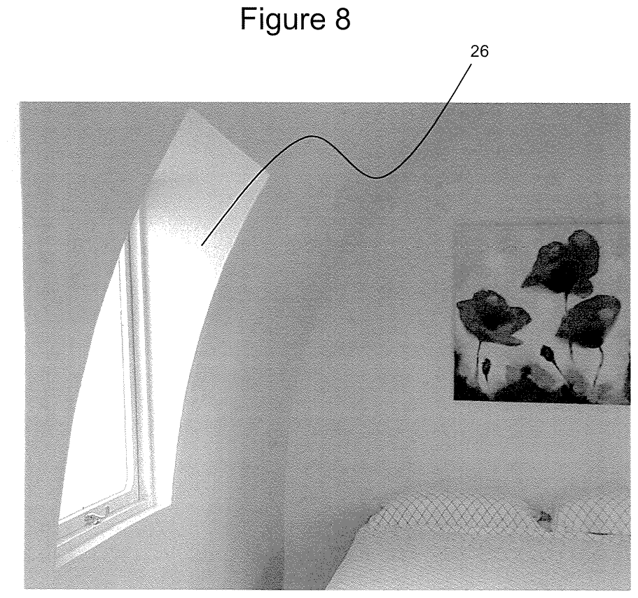

In some embodiments of the invention buildings produced according to at least the FIGS. 1 and 5 embodiments may include one or more windows. An example of such window is shown in FIG. 8. The window 26 is formed in the same manner as the door in that a window frame is placed against the mould and sprayed over with the polyurethane foam. An enveloping polyurea skin is then sprayed as above. The window frame may be formed from any suitable substance, but is preferably wooden, for example plywood (eg 17-20 mm thick). It may be held against the mould in an elevated disposition prior to spraying, by screws or any other suitable fixing means.

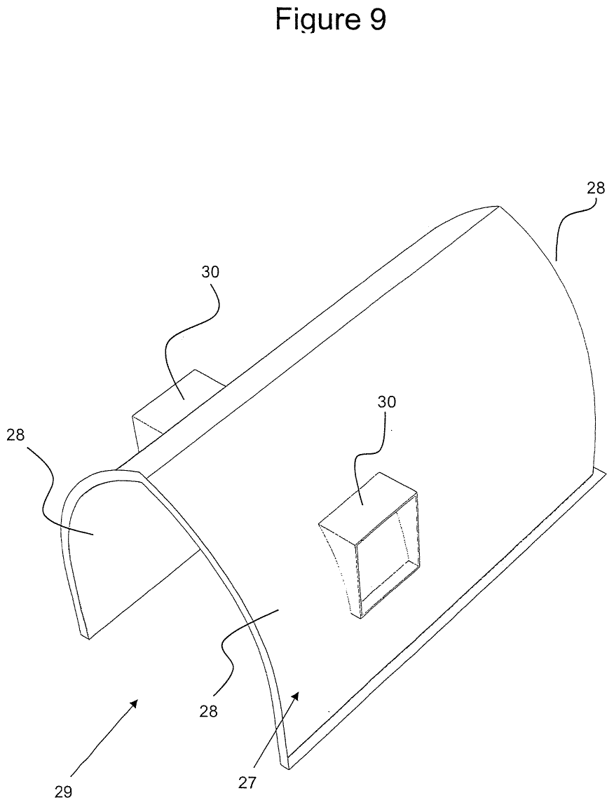

FIG. 9 illustrates an alternative metallic mould 27 which has three sides 28 and an open front 29. Window frames 30 of the same sort described above are arranged on the mould in an elevated disposition. The mould 27 is sprayed over with polyurethane foam to embed the window frames as above (ie except the parts that touch the mould) and an enveloping polyurea skin is then applied.

Preferably in each embodiment a suitable liquid wax is applied to the mould before spraying the polyurethane, so as to make it easier to remove the polyurethane when cured. While applied in liquid form, solvent carrying the wax evaporates after application, leaving a solid wax coating behind. In each case the outer face of the mould that receives the polyurethane is smooth so as to enhance the aesthetics of the interior of the finished building.

In some embodiments of the invention inserts may be added to the mould before spraying with polyurethane, in each case to cause channels to form within the polyurethane to accommodate electrical outlet sockets or building services such as pipes and cables, etc.

Advantages of at least some embodiments of the invention are—
the polyurethane and polyurea are not prone to rotting and therefore the building is less prone to water damage;
the same mould can be used for buildings of thicker or thinner walls;
there is no need to separate mould halves by releasing associated clamps or other fixings to remove a sandwiched panel or building (ie because the polyurethane is sprayed on only one side of the mould);
the position of a door or window can be changed without having to have different moulds for each new position;
as door and window frames are moulded in they are less likely to be points of undesired water ingress; and
buildings can be formed to have an outside rough cast appearance, or a smooth appearance, depending on the skill of the person spraying the polyurethane.

By way of example, in each case mentioned above the polyurethane foam is preferably Zero ODP Polyurethane Spray Foam Insulation, Endurathane SR42M, available from the Polymer Group Ltd, Auckland, New Zealand. In each case the polyuria is preferably Pure Polyurea Spray Lining, Endurathane P-515 available from the same supplier.

While some embodiments of the invention have been described by way of example it should be appreciated that modifications and improvements can occur without departing from the scope of the following claims.

1. A method of forming a building, comprising at least the steps of:
arranging at least one edge support frame at a mould;
spraying a first spray material onto the outside of the mould so that the spray material;
sets generally in the shape of the mould; and
substantially embeds the frame;
removing the first spray material and the frame from the mould;
spraying a second different spray material onto the first spray material to provide a skin therefor; and
connecting the panel to other panels that have been formed in substantially the same way such that they join end to end.

2. A method according to claim 1, wherein spraying the first spray material is such that a door frame and/or window frame is also embedded in the first spray material.

3. A method according to claim 1, wherein the first spray material comprises polyurethane foam.

4. A method according to claim 1, wherein the second spray material comprises polyurea.

5. A method according to claim 1, used to produce a wall-roof combination panel for use as part of the building.

6. A method according to claim 5, wherein the edge support frame is substantially embedded at an edge of the panel.

7. A method according to claim 1, wherein the second spray material envelopes the first spray material and the frame.

8. A method according to claim 1, wherein part of the skin is applied before the first spray material is removed from the mould.

9. A method according to claim 1, wherein the mould is curved in at least its vertical dimension for producing a complimentary shaped wall-roof combination panel.

10. A method according to claim 1, wherein the mould has a central ridge running vertically for forming a complimentary shaped ridge in a wall-roof combination panel.

11. A method according to claim 10, wherein the door frame straddles the central ridge to provide for a door opening in the wall-roof combination panel.

12. A method according to claim 1, wherein there are at least two of the edge support frames, one at each side of a wall-roof combination panel.

13. A method according to claim 12, wherein at least one of the edge support frames comprises a wooden beam.

14. A method according to claim 12, wherein the mould gives the wall-roof panel a stepped end.

15. A method according to claim 1, wherein the mould is metallic and is used to create a series of individual separate wall-roof combination panels for the building, and such that:
the first spray material comprises polyurethane foam;
the second spray material comprises polyurea;
there are at least two of the edge support frames per panel, each support frame substantially embedded in and running upwards along a different end of the panel;
each panel is formed to have a joining step at at least one end;
the panels are arranged end-to-end in overlapping fashion at the joining steps;
fasteners are driven through the ends of the panels to connect them so that each fastener passes through the support frames of adjoining panels to hold them together;
each panel has a central ridge;
each panel curves inwards with respect to the building as the panel extends upwards;
at least one of the panels has a door frame substantially embedded in the polyurethane; and
at least one of the panels has a window frame substantially embedded in the polyurethane.

16. A method according to claim 15, wherein the door frame extends across either side the central ridge of the respective panel.

17. A method according to claim 15, wherein window frames are placed on the same mould in different positions for different panels formed for the same building, to give each panel a differently disposed window space.
